(19) United States
(12) Patent Application Publication
(10) Pub. No.: US 2005/0287331 A1
(43) Pub. Date: Dec. 29, 2005

(54) Optical disc

(75) Inventors: Hitoshi Noguchi, Gifu-shi (JP); Masahiro Higuchi, Anpachi-gun (JP); Yoshiaki Maeno, Mizuho-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: SANYO MARVIC MEDIA CO.,LTD, Anpachi-gun (JP); SANYO ELECTRIC CO., LTD., Moriguchi-shi (JP)

(21) Appl. No.: 11/140,000

(22) Filed: May 31, 2005

(30) Foreign Application Priority Data
Jun. 1, 2004 (JP) JP 2004-163050
Jun. 14, 2004 (JP) JP 2004-175828

(51) Int. Cl. B32B 3/02

(52) U.S. Cl. 428/64.4

(57) ABSTRACT

The present invention was made to improve the strength, such as heat resistance, of a disc comprising a biodegradable resin. The optical disc according to the present invention is formed by bonding two substrates, at least one of the substrates having an information recording area. One substrate disposed on a light incident side of the optical disc is composed of a biodegradable resin that is uncrystallized and allows light to transmit therethrough. Another substrate disposed away from the light incident side of the optical disc is composed of the biodegradable resin having higher crystallinity than that of the substrate disposed on a light incident side of the optical disc.

The priority application Numbers JP2004-163050 and JP2004-175828 upon which this patent application is based are hereby incorporated by reference.

### BACKGROUND OF THE INVENTION

1. Field of the Invention

The present invention relates to an optical disc formed by bonding two substrates, at least one of the substrates having an information recording area, such as DVDs (Digital Versatile Discs), and to the optical disc for reducing environmental burdens.

2. Description of the Prior Art

Not only information for computers but also information of sounds, still images, and moving images has been digitalized, and the amount of which is enormous. Optical discs are used as media to store such enormous amount of information. The optical discs include: a single-layer type optical disc in which an information recording layer is formed on a transparent polycarbonate resin substrate; a bonded-type optical disc formed by bonding two discs for the purpose of increasing recording capacity; and etc. Because the demand for increasing density of recording media has been intensified recently, the bonded-type optical discs are more widely used including the optical disc with the transparent substrate bonded.

By the way, when the above-mentioned optical discs become unnecessary, the optical discs must be incinerated or landfilled since polycarbonate resin is used for their substrates. Such waste processing contains some problems in view of environmental issues, requiring measures of some kind.

In view of the problems, optical discs have been proposed comprising a biodegradable resin base that breaks down in nature (e.g. Japanese unexamined patent publication No.2000-11448).

### SUMMARY OF THE INVENTION

However, the biodegradable resin used in the optical disc has a glass transition temperature as low as 60 degrees centigrade. Because of this low glass transition temperature, the optical disc often suffers great warping by a temperature rise during recording and playback or under other conditions. Poor heat resistance caused by the low glass transition is one of the problems of the optical disc composed of biodegradable resin.

The present invention is made to solve the above-mentioned previously known problems, and to improve strength, such as heat resistance, of the optical discs composed of the biodegradable resin.

The optical disc according to the present invention, is comprised of two bases, at least one of the bases having an information recording area, bonded with each other, and is characterized in that one of the bases disposed on a light incident side of the disc is composed of a light-transmitting biodegradable resin and another base disposed away from the light incident side is composed of a biodegradable resin having higher heat resistance than that of the base on the light incident side.

According to the above structure, heat resistance and mechanical strength of the entire optical disc, which is formed by bonding two biodegradable resin bases, can be improved since the biodegradable resin used for one of the bases has relatively high heat resistance and high mechanical strength.

In the present invention, the biodegradable resin of the base disposed away from the light incident side has higher crystallinity than that of the base on the light incident side.

Furthermore, the base disposed away from the light incident side can be a dummy substrate. The information recording area can be formed on the base disposed away from the light incident side.

At least one surface of the optical disc is coated with a dielectric film. The dielectric film can be applied over a light incident surface of the optical disc.

The dielectric film can be composed of a silicon nitride film or an aluminum nitride film. The silicon nitride film functioning as the dielectric film preferably has a thickness of 300 nm.

Since the dielectric film has a smaller linear expansion coefficient than that of the biodegradable resin, the optical disc improves heat resistance, thereby reducing the warp caused by the temperature rise.

### BRIEF DESCRIPTION OF THE DRAWINGS

FIG. 1 is a cross-sectional diagram of a DVD as an optical disc according to the first embodiment of the present invention.

FIG. 2 is a cross-sectional perspective view partially showing the structure of a phase-change optical disc as an example of the DVD according to the first embodiment of the present invention.

FIG. 3 is a cross-sectional perspective view partially showing the structure of a phase-change optical disc, as an example of the DVD according to the second embodiment of the present invention.

FIG. 4 is a cross-sectional perspective diagram showing the third embodiment of the present invention.

FIG. 5 is a plan view of an optical disc according to the fourth embodiment of the present invention.

FIG. 6 is a schematic diagram showing the structure of an RF magnetron sputtering system used to manufacture the optical discs according to the present invention.

FIG. 7 is a plan view showing a substrate holder of the RF magnetron sputtering system used to manufacture the optical discs according to the present invention.

FIG. 8 is a cross-sectional diagram showing the structure of an optical disc provided with a dielectric film on a light incident surface of the optical disc to measure heat resistance property of the optical disc according to the present invention.

FIG. 9 is a diagram describing a warp angle of a substrate of the optical disc.

FIG. 10 is a graph showing measurement results of a heat resistance test to the optical disc according to the present invention.

FIG. 11 is a graph showing measurement results of the heat resistance test to the optical disc according to the present invention.

FIG. 12 is a graph showing measurement results of the heat resistance test to the optical disc according to the present invention.

The foregoing and other objects, features, aspects and advantages of the present invention will become more apparent from the following detailed description of the present invention when reviewed in conjunction with the accompanying drawings.

### DETAILED DESCRIPTION OF THE PREFERRED EMBODIMENTS

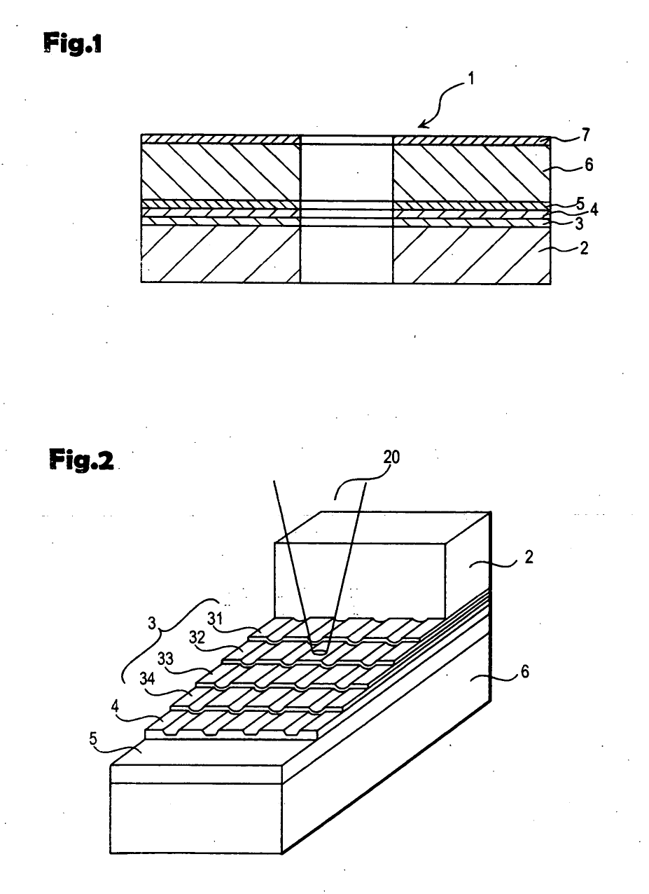

Embodiments of the present invention will be described with reference to drawings. Elements that are same or equivalent in the drawings are denoted with the same reference numbers and their descriptions are not repeated. FIG. 1 is a cross-sectional diagram of a DVD as an optical disc according to the first embodiment of the present invention. FIG. 2 is a cross-sectional perspective view partially showing the structure of a phase-change optical disc as an example of the DVD according to the first embodiment of the present invention.

In an optical disc 1 shown in FIG. 1, an optical recording layer 3 and a protective layer 4 are provided on a main surface of a light-transmitting substrate 2 in the shape of a circular plate, and then a resin substrate 6 is bonded to the protective layer 4 through an adhesive layer 5. A printing layer 7 is provided on the resin substrate 6. The optical recording layer 3 comprises a recording area formed on the light-transmitting substrate 2 and a reflective layer formed on the recording area. The recording area comprises pits, which are microscopic projections and depressions to translate information, or a groove. The protective layer 4 can be omitted if unnecessary. Actually there are some optical discs not comprising the protective layer 4.

The optical disc 1 is a single-sided DVD formed by bonding, for example, a substrate 2 having a thickness of about 0.6 mm and a substrate 6 having a thickness of about 0.6 mm. The substrate 6 adjacent to the printing layer 7 is a dummy substrate that has no influence on recording and playback of the disc. Although the thicknesses of the substrates 2 and 6 are set at about 0.6 mm, the thicknesses may be slightly different depending on the refractive index of the resin in use. In other words, the thickness of the substrate should be changed according to the refractive index of the resin in use. This is for ensuring compatibility. The product of the thickness of the polycarbonate substrate (0.6 mm) and the refractive index of polycarbonate (1.58) is regarded as a reference value. The product of the thickness of every resin and the refractive index of the resin should be equal to the reference value to ensure the compatibility. The refractive index of the biodegradable resin is less than that of the polycarbonate; therefore, the biodegradable resin substrate should be thickened more than 0.6 mm by about 2%.

FIG. 2 is a cross-sectional perspective view partially showing the structure of a phase-change optical disc as an example of the DVD. As shown in FIG. 2, lines of the groove for tracking are formed, by use of a stamper, on the substrate 2 with a thickness of about 0.6 mm, and lines of a land are formed therebetween. A dielectric layer 31, a recording layer 32, a dielectric layer 33 and a reflective layer 34 comprise the optical recording layer 3. The protective layer 4 is then provided on the reflective layer 34. On the protective layer 4 bonded is the substrate 6 with a thickness of about 0.6 mm as a dummy substrate through the adhesive layer 5. A laser beam 20 is irradiated from the substrate 2 side.

In consideration of the environment, the substrate 2 is a so-called injection-molded resin substrate that is integrally made of a biodegradable resin which breaks down in nature. Similarly, the substrate 6 is a so-called injection-molded resin substrate that is integrally made of a biodegradable resin which breaks down in nature. However, the biodegradable resin used for the substrate 6 is prepared at the expense of optical characteristics to increase heat resistance and mechanical strength, since the substrate 6 does not influence recording and playback of the disc as described above.

Degradable resins in nature include a biodegradable resin that is degraded by microorganisms and a resin that is degraded by water, ultraviolet ray and so on. In the biodegradable resins having transparency, a representative example is a resin whose main raw material is PLA (polylactic acid) extracted from corn. For example, there are “LACTY (trade name)” by Toyota Motor Corporation, “LACEA (trade name)” by Mitsui Chemicals, Inc. and “TERRAMAC (trade name)” by Unitika Ltd. For information, LACTY, LACEA and TERRAMAC are trademarks in Japan.

Since the optical disc 1 receives laser beams from the substrate 2 side, the substrate 2 should be composed of a biodegradable resin with excellent optical characteristics. When the biodegradable resins contain completely same ingredients, an increase in crystallinity degrades optical characteristics of the resins, but improves heat resistance and mechanical strength. Hence, a crystallized biodegradable resin is used for the substrate 6, while an uncrystallized biodegradable resin is used for the substrate 2 to give a priority to optical characteristics.

The dielectric protective layers 31 and 33 are dielectrics composed of a compound of ZnS and SiO₂, and the recording layer 32 is a phase-change layer composed of AgInSbTe or GeSbTe. The reflective layer 34 is also made of materials degradable by oxygen, water and so on in nature or materials exist in nature such as underground minerals. For example, a single-layer film of aluminum or iron, a multilayer film of aluminum and iron, or an alloy containing aluminum or iron is used for the reflective layer 34. In the case of using iron whose reflectivity is relatively low, a multilayer film in which a silicon oxide thin film and a silicon thin film are laminated on an iron thin film can be used to compensate for the low reflectivity.

The protective layer 4 formed on the reflective layer 34 is also comprised of a biodegradable resin, which breaks down in nature, like the substrate 2. The protective layer 4 can be formed, for example, by spin-coating the biodegradable resin and then curing the coated film. Thus formed protective layer 4 generally has a thickness in the range of 0.1″m to 100″m.

The light-transmitting substrate 2 with the optical recording layer 3 and the protective layer 4 formed thereon and the substrate 6 functioning as a dummy substrate are bonded via the adhesive layer 5. It is possible to use a UV curable resin as the adhesive layer 5, but it is preferable to use a biodegradable adhesive resin. If the adhesive layer 5 can be composed of biodegradable adhesive materials, the adhesive layer 5 breaks down in nature with other parts of the disc, which is preferable. Available biodegradable adhesive includes adhesive such as animal glue, gelatin and starch and lactic-acid base resins. In the case of the animal glue, the animal glue is made into animal glue solution to apply over the protective layer 4 by spin coating. Then the protective layer 4 is bonded to the substrate 6.

As described above, the substrate 2 to which the laser beam 20 is incident is made of a biodegradable resin having excellent light transmissivity and optical characteristics. On the other hand, the substrate 6 functioning as a dummy substrate is made of a biodegradable resin having high heat resistance and high mechanical strength. The substrate 6 to which the laser beam 20 is not incident does not influence recording and playback.

As described above, when the biodegradable resins contain completely same ingredients, the heat resistance and mechanical strength of the biodegradable resins are improved by increasing crystallinity. Table 1 shows results of an annealing test. Biodegradable resins were annealed at a temperature of 80 degrees centigrade and a humidity of 40% for time periods up to 2 hours in increments of 15 minutes. The crystallinity and transmissivity were measured at the end of each time period. The biodegradable resins used in this test were “H-100J (product name)” of “LACEA” by Mitsui Chemicals, Inc.

TABLE 1

| | annealing time periods (minutes) | | | | | | | |
|---|---|---|---|---|---|---|---|---|
| | 15 | 30 | 45 | 60 | 75 | 90 | 105 | 120 |
| transmissivity | 85% | 82% | 81% | 80% | 78% | 79% | 78% | 77% |
| crystallinity | 0% | 25% | 31% | 32% | 33% | 33% | 33% | 34% |

As shown in Table 1, with an increase in time periods for annealing, the crystallinity increased and became saturated after 60 minutes. The transmissivity decreased with an increase in the crystallinity. The transmissivity dropped from 85% to 78% when the crystallinity rose from 0% to 33%. As appreciated from the results, when the crystallinity increased, the transmissivity deteriorated. It is understood that a biodegradable resin with low crystallinity is suitable for the substrate 2 to which the laser light is incident. The biodegradable resin with 0% crystallinity also had the best transmissivity. Therefore, in this embodiment, the biodegradable resin with 0% crystallinity is used for the substrate 2 to which laser light is incident.

Furthermore, with an increase in crystallinity, the heat resistance represented by melting point and the mechanical strength represented by breaking strength and Young's modulus are improved. If the crystallinity becomes 30%, for example, above-described items are increased by 10% or more. Although the crystallinity became saturated at 34% in the annealing test, the crystallinity can be increased by selecting different materials, since crystallinity saturation is different depending on the materials. Also, the crystallinity can be changed by using different methods for molding the resin. For example, if the resin in a mold is rapidly cooled down, the crystallinity can be further increased. Thus, in this embodiment, a substrate using a biodegradable resin with high crystallinity is used as the substrate 6 functioning as a dummy substrate that does not influence recording and playback.

Use of the biodegradable resin with the excellent heat resistance and mechanical strength for the dummy substrate that does not influence recording and playback improves the heat resistance and mechanical strength of the entire optical disc composed of the biodegradable resin and formed by bonding two substrates.

Then, an optical discs made of “H-100J” were annealed at a temperature of 80 degrees centigrade and a humidity of 40% for two hours to examine a heat resistance property. The heat resistance was figured out by measuring a warp of substrates of CDs. The warp was measured: (1) when a substrate was just formed (initial state); (2) after annealing a substrate for 2 hours at a temperature of 80 degrees centigrade and a humidity of 40%; (3) after running a heat resistance test on an annealed substrate for 2 hours at a temperature of 60 degrees centigrade and a humidity of 40%; and (4) after running the heat resistance test on a substrate for 2 hours at a temperature of 65 degrees centigrade and a humidity of 40%. For reference purposes, other optical discs made of“H-100J” were subjected to the above heat resistance test without annealing. Each of the sample optical discs comprises an optical recording layer, a protective film and a printing layer that are laminated on a surface of a substrate made of “H-100J” with a thickness of 1.2 mm.

The warp of an optical disc was obtained by measuring a warp angle. As shown in FIG. 9, the warp angle is determined by calculating an angle alpha between an incident beam 120 and a reflected beam 121. Specifically, an incident beam 120 is irradiated from a laser that is disposed on the side of a read-out surface 106 of a substrate 102 so that the incident beam 120 orthogonally crosses a reference plane 122 of the read-out surface 106 of the substrate 102. The incident light 120 is reflected on a recording layer 103. Thus, the angle alpha is obtained from the incident beam 120 and the reflected beam 121. Warp angles generally include a radial warp angle and a tangential warp angle. In this measurement, three radial warp angles and three tangential warp angles each at 25 mm, 40 mm and 55 mm from the center of the optical disc are averaged out to determine warp angles. The negative value of the warp angle means that the substrate warps toward a pick-up, while positive value means that the substrate warps away from the pick-up.

The results are shown in Table 2 and Table 3.

TABLE 2

| | | | Heat resistance |
|---|---|---|---|
| Radial | Initial state | Annealing at 80° C. | test at 60° C. |
| position | warp angle (deg.) | warp angle (deg.) | warp angle (deg.) |
| 25 mm | 0.16 | −0.14 | −0.31 |
| 40 mm | 0.20 | 0.03 | 0.20 |
| 55 mm | 0.04 | −0.63 | −0.51 |

TABLE 3

| | | | Heat resistance |
|---|---|---|---|
| Radial | Initial state | Annealing at 80° C. | test at 65° C. |
| position | warp angle (deg.) | warp angle (deg.) | warp angle (deg.) |
| 25 mm | 0.09 | 0.00 | −0.12 |
| 40 mm | 0.05 | 0.13 | 0.01 |
| 55 mm | −0.13 | −0.51 | −0.61 |

Table 2 and Table 3 show that the crystallization improved by annealing enhanced the heat resistance. The warp angles after annealing at the 55 mm radial position, which is adjacent to the periphery of the optical disc, were −0.63 degrees and −0.51 degrees, which are the largest values. The warp angles changed a little to −0.51 degrees and −0.61 degrees, respectively, after the heat resistance test. Hence it is understood that the heat resistance has been improved. On the other hand, the optical discs made of “H-100J” subjected to the heat resistance test without annealing warped too much to measure.

Therefore, the dummy substrate 6 made of “H-100J” is annealed, for example, at a temperature of 80 degrees centigrade and a humidity of 40% for two hours to enhance its crystallinity, thereby improving strength such as the heat resistance. The maximum warp angle of the substrate is −0.63 degrees, as shown in Table 2 and Table 3, which does not cause trouble to the dummy substrate. By bonding this dummy substrate with the substrate 2 made of “H-100J”, it is possible to provide an optical disc with an excellent heat resistance property.

Although biodegradable resins containing same ingredients but having different crystallinity were used to form the substrate 2 and substrate 6 in the above embodiment, an opaque biodegradable resin, for example, can be also used for the substrate 6 functioning as a dummy substrate, which does not influence recording and playback, as long as the resin has high heat resistance and high mechanical strength. As the opaque biodegradable resin, product name “M-151SQ04” in “LACIA” by Mitsui Chemicals, Inc. is available, for example. “M-151SQ04” has a thermal deformation temperature (0.45 Mpa) of 66 degrees centigrade, which is superior in heat resistance by at least 20% to “H-100J” having a thermal deformation temperature of 53 degrees centigrade. Additionally, Izot impact strength of “M-151SQ04” is 43 J/m, which is superior in mechanical strength to “H-100J” having Izot impact strength of 29 J/m. Therefore, the use of “M-151SQ04” to form the substrate 6 functioning as a dummy substrate can improve the heat resistance and mechanical strength of the optical disc formed by bonding two substrates made of the biodegradable resin.

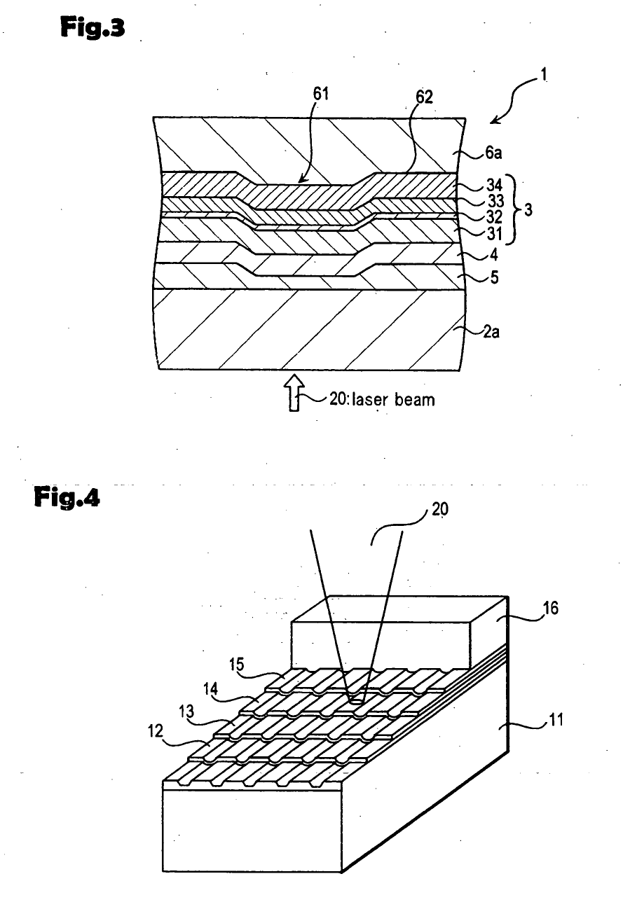

FIG. 3 is a cross-sectional perspective view showing the second embodiment of the present invention. Elements in FIG. 3 identical with elements in FIG. 1 and FIG. 2 are denoted with the same reference numbers and their descriptions are not repeated.

In the first embodiment shown in FIG. 1 and FIG. 2, the substrate 2 located on a side to which a laser beam is incident is provided with a recording area including pits, which are microscopic projections and depressions to translate information, or a groove. On the other hand, in the second embodiment, the recording area including pits or a groove is provided on a substrate 6a located on a side to which laser light is not incident. In other words, the substrate 6a composed of a biodegradable resin with high heat resistance and mechanical strength comprises a recording area including pits or a groove.

FIG. 3 shows a structure of a phase-change optical disc according to the second embodiment of the present invention. The phase-change optical disc comprises a substrate 6a having a thickness of about 0.6 mm with a groove 61 for tracking formed by a stamper and lines of a land 62 therebetween. On the tracking groove 61 formed are a reflective layer 34, a dielectric layer 33, a recording layer 32 and a dielectric layer 31 in this order. The dielectric layer 33, the recording layer 32, the dielectric layer 31 and the reflective layer 34 comprise an optical recording layer 3. A protective layer 4 with an adhesive layer 5 thereon is provided on the optical recording layer 3.

This adhesive layer 5 bonds with a substrate 2a on the light incident side. The substrate 2a has a thickness of 0.6 mm and is made of a biodegradable resin with excellent optical characteristics including transmissivity. A laser beam 20 is irradiated from the side of the substrate 2 a.

Since the laser beam is incident from the side of the substrate 2, a biodegradable resin for the substrate 2 should have good optical characteristics but should not been crystallized. As described above, when the biodegradable resins contain completely same ingredients, an increase in crystallinity deteriorates the optical characteristics but improves heat resistance and mechanical strength of the biodegradable resins. Hence, a crystallized biodegradable resin is used for the substrate 6a.

Although biodegradable resins containing same ingredients but having different crystallinity are used to form the substrate 2 and the substrate 6 in the above embodiment, an opaque biodegradable resin, for example, can be used for the substrate 6 functioning as a dummy substrate, which does not influence recording and playback, as long as the resin has high heat resistance and high mechanical strength. As the opaque biodegradable resin, product name “M-154SQ04 ” in “LACIA” by Mitsui Chemicals, Inc. is available, for example. “M-154SQ04 ” has a thermal deformation temperature (0.45 Mpa) of 66 degrees centigrade, which is superior in heat resistance by at least 20% to “H-100J” having a thermal deformation temperature of 53 degrees centigrade. Additionally, Izot impact strength of “M-154SQ04 ” is 43 J/m, which is superior in mechanical strength to “H-100J” having Izot impact strength of 29 J/m. Therefore, by the use of “M-154SQ04 ” to form the substrate 6 functioning as a dummy substrate, the optical disc formed by bonding two substrates made of the biodegradable resin can improve its heat resistance and mechanical strength.

Since the recording area including pits, which are microscopic projections and depressions to translate information, or a groove is provided on the substrate 6 a with improved heat resistance and mechanical strength, as described above, the pits or the groove does not deform. Even if temperature rises, stable reproducibility can be realized due to the excellent heat resistance.

Although the recording area is provided on one side of the optical disc in the above embodiments, the present invention is not limited to this. It is also applicable to an optical disc having a plurality of recording layers, such as an optical disc having two recording layers on one side.

FIG. 4 is a cross-sectional perspective diagram showing the third embodiment of the present invention. Although the above first and second embodiments were described on the present invention applied to a DVD, the third embodiment will be described on the present invention applied to a Blu-ray disc. Both the Blu-ray disc and the DVD have a thickness of 1.2 mm, but their structures are different from each other. The Blu-ray disc broadly comprises a disc substrate with a thickness of 1.1 mm and a cover layer with a thickness of 0.1 mm. In this third embodiment, a biodegradable resin having high heat resistance and mechanical strength is used for the 1.1 mm disc substrate, and an un-crystallized biodegradable resin having excellent optical characteristics is used for the cover layer to which light is incident. In Japan, Blu-ray Disc is a trademark.

With reference to FIG. 4, descriptions will be made on the third embodiment of the present invention. Pits, which are microscopic projections and depressions to translate information, and lines of a groove are formed by a stamper on a biodegradable resin substrate 11 with a thickness of 1.1 mm. On the substrate 11 formed are a reflective layer 12, a protective layer 13, a recording layer 14 and a protective layer 15. An adhesive layer (not shown) is provided on the protective layer 15.

A cover layer 16, which has a thickness of 0.1 mm and is composed of a biodegradable resin having excellent optical characteristics including transmissivity, is bonded through the adhesive layer with the protective layer 15. A laser beam 20 is incident from the cover layer 16 side.

Since the laser beam is incident from the cover layer 16 side, an uncrystallized biodegradable resin with excellent optical characteristics is used for the cover layer 16. As described above, when the biodegradable resins contain completely same ingredients, an increase in crystallinity deteriorates the optical characteristics but improves the heat resistance and mechanical strength of the biodegradable resins. Hence, a crystallized biodegradable resin is used for the substrate 11.

Since the recording area including pits, which are microscopic projections and depressions to translate information, or a groove is provided on the substrate 11 with improved heat resistance and mechanical strength, as described above, the pits or the groove does not deform. Even if temperature rises, stable reproducibility can be realized due to the excellent heat resistance.

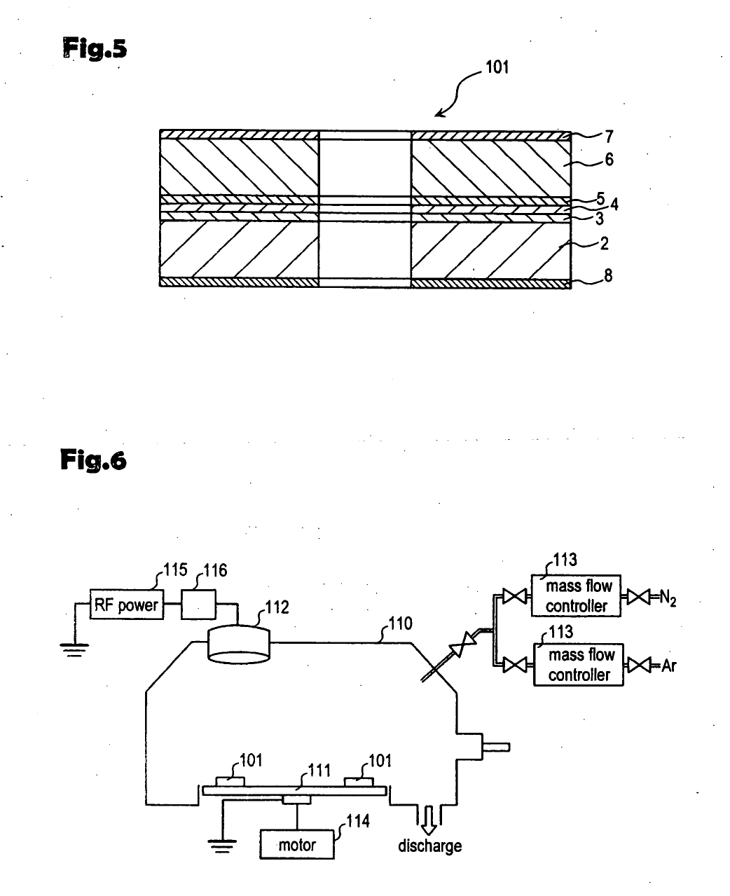

FIG. 5 is a schematic cross-sectional view of an optical disc according to the fourth embodiment of the present invention. The fourth embodiment shows an optical disc having higher heat resistance than that of the first embodiment.

In the fourth embodiment, a dielectric film 8 is provided by a sputtering method on a light incident surface of a substrate 2 located on the light incident side of the disc. As the dielectric film 8, a silicon nitride film or an aluminum nitride film is used.

By the way, a linear expansion coefficient of the biodegradable resin comprising the substrate 2 (or a substrate 6) is 8.8×10⁻⁵/degrees centigrade. Linear expansion coefficients of silicon nitride and aluminum nitride comprising the dielectric film 8 are 2.9×10⁻⁶/degrees centigrade and 4.6×10⁻⁶/degrees centigrade, respectively. In short, the linear expansion coefficients of the dielectric film 8 are smaller than that of the biodegradable resin of the substrate 2 (or substrate 6). By depositing the dielectric film 8 on the substrate 2 (or substrate 6), the linear expansion coefficient of the dielectric film 8 and the linear expansion coefficient of the substrate 2 (or substrate 6) bring a good balance of tension, thereby reducing the warp caused by temperature rise.

The silicon nitride film or the aluminum nitride film functioning as the dielectric film 8 is provided by a sputtering method on the light incident surface of the substrate 2.

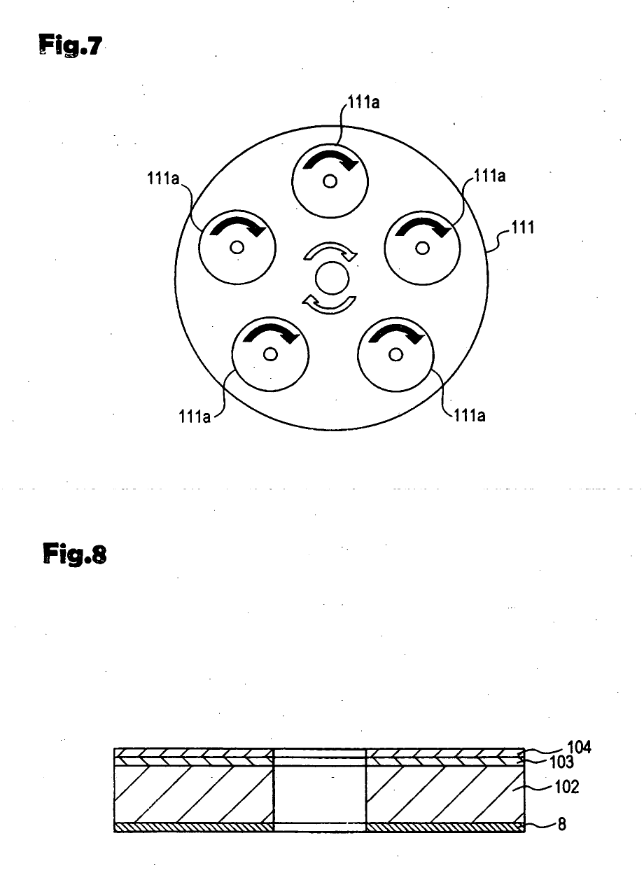

An example method of forming the dielectric film 8 will be described. The film is formed by an RF magnetron sputtering system shown in FIG. 6 and FIG. 7, for example. As shown in FIG. 6, a disciform target 112 is placed in a vacuum chamber 110 in this sputtering system. Silicon is used as the target 112 to form the silicon nitride film, while aluminum is used to form the aluminum nitride film.

A mix gas of Argon (Ar) and nitrogen (N₂) is used as a sputtering gas. Mass flow controllers 113 control the flow rate of the sputtering gas and introduce it into the chamber 110. The film grows under a constant gas pressure of 0.93 Pa. The mixing ratio of the gas is 3 sccm N₂ gas to 50 sccm Ar gas. Optical discs 101 are mounted on a substrate holder 111. The substrate holder 111 is rotated on its axis by a motor 114, and each optical disc 101 mounted on the substrate holder 111 rotates on its axis and revolves about the axis of the substrate holder 111. As shown in FIG. 7, the substrate holder 111 is provided with substrate mounting holders 111a. The substrate holder 111 rotates on its axis, and also turns the substrate mounting holder 111a. Hence, the optical discs 101 set on the substrate mounting holders 111a rotate on their own axes and revolve about the axis of the substrate holder 111. The target 112 is applied with 500 W RF power, whose impedance is matched in a matching box 116, from an RF power generator 115.

The silicon nitride (SiN) film functioning as the dielectric film 8 is thus formed in the above-descried system. Silicon (Si) is used as the target 112. The substrate holder 111 rotates at 20 rpm. The film is formed at a deposition rate of 30 angstrom/min. The rotation and revolution of the optical disc 101 bring about excellent film thickness distribution. The deposition of SiN is performed only when the disc passes through the target 112, thereby limiting a rise of the substrate temperature. The film can be formed at a low substrate temperature of 40 degrees centigrade or lower under the above-described conditions.

Optical discs, as shown in FIG. 8, in which an optical recording layer 103 and a protective layer 104 were deposited on a surface of a substrate 102 and a dielectric film 8 was formed on a light incident surface of the substrate 102, were prepared to perform a heat resistance test. The substrate 102 was composed of “H-100J” in “LACEA” by Mitsui Chemicals, Inc. The optical recording layer 103 was an aluminum thin film having a thickness of 40 nm. The protective layer 104 was formed, for example, by spin coating a biodegradable resin and then curing the coated film. The heat resistance test was conducted to the optical disc having the structure shown in FIG. 8, with a silicon nitride (SiN) film as the dielectric film 8, under the conditions of a temperature of 50 degrees centigrade and a humidity of 40% for 5 hours. Three types of optical discs were prepared, each type having a silicon nitride (SiN) film with a thickness of 100 nm, 150 nm or 300 nm. Warps of the substrates before and after the test were measured.

The warp of an optical disc was obtained by measuring a warp angle. Similarly to the above-described test, the warp angle is determined by calculating an angle alpha between an incident beam 120 and a reflected beam 121 as shown in FIG. 9. In this measurement, radial warp angles and tangential warp angles at radius positions from the center of the optical disc (in the range from 22 mm to 60 mm) were averaged out to determine the warp angles. The negative value of the warp angle means that the substrate warps toward a pick-up, while positive value means that the substrate warps away from the pick-up.

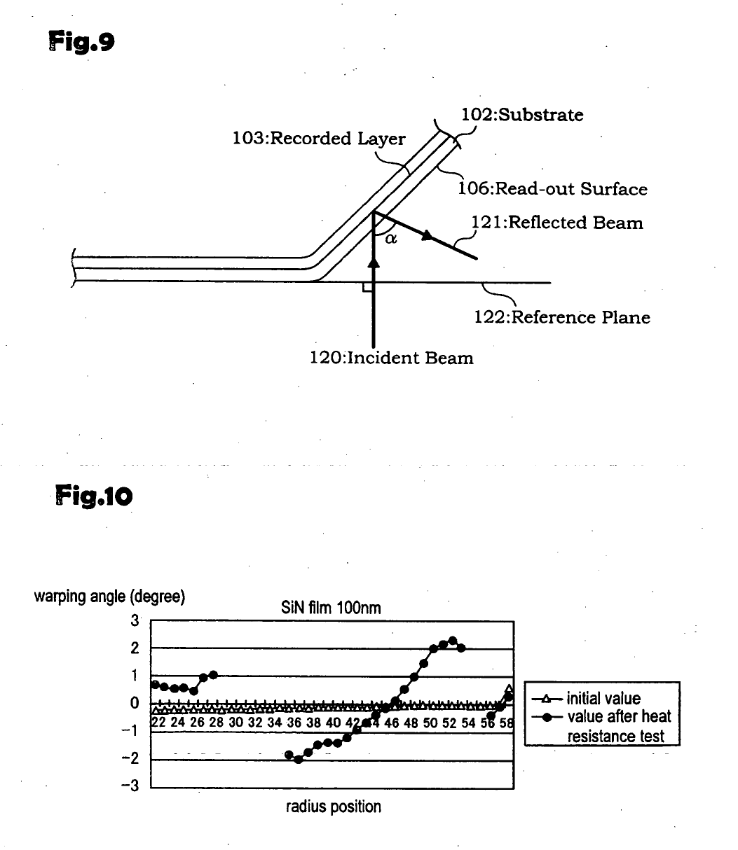

FIGS. 10, 11, and 12 show test results on the optical discs having the 100 nm silicon nitride (SiN) film, the 150 nm silicon nitride (SiN) film, and the 300 nm silicon nitride (SiN) film, respectively.

As appreciated from FIG. 10 to FIG. 12, the 300 nm silicon nitride (SiN) film was noticeably superior in reducing the warp to the 100 nm and 150 nm silicon nitride (SiN) films. The warp angle of the optical disc 1 comprising the 300 nm silicon nitride (SiN) film was approximately 1.5 degrees, which proves that most warps could be prevented. From the results, it is understood that thickening the silicon nitride (SiN) film to some extent effectively reduces the emergence of the warp, therefore, the dielectric film 8 that is a silicon nitride (SiN) film having a thickness of 300 nm can fully prevent the optical disc from warping.

Thus, the provision of the dielectric film 8 can improve the heat resistance.

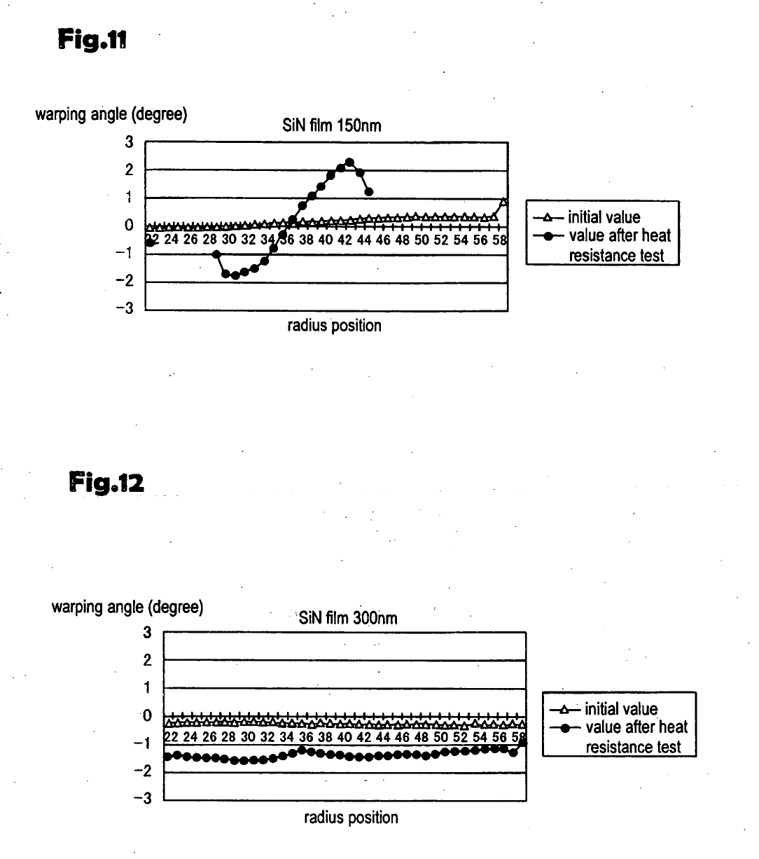

As shown in FIG. 10 and FIG. 11, the measurement could not be performed in places on the disc comprising the 100 nm and 150 nm silicon nitride (SiN) films. This is because cracks and so on were produced in the silicon nitride (SiN) films during the heat resistance test.

In the above embodiments, it was recognized that the warp of the optical disc was reduced by providing the dielectric film 8 on the light incident surface of the optical disc. Of course, the optical disc comprising the dielectric films 8 on both surfaces of the optical disc can also reduce the warp.

It should be understood that the embodiments disclosed herein are to be taken as examples and not limited. The scope of the present invention is defined not by the above described embodiments but by the following claims. All changes that fall within meets and bounds of the claims, or equivalence of such meets and bounds are intended to be embraced by the claims.

1. An optical disc comprising:
two bases, at least one of the bases having an information recoding area, wherein
one of the bases disposed on a light incident side of the optical disc is composed of a light-transmitting biodegradable resin; and
another base disposed away from the light incident side of the optical disc is composed of a biodegradable resin having higher heat resistance than that of the base on the light incident side.

2. The optical disc according to claim 1, wherein the base disposed away from the light incident side of the optical disc is composed of the biodegradable resin having higher crystallinity than that of the base on the light incident side of the optical disc.

3. The optical disc according to claim 1, wherein the base disposed away from the light incident side of the optical disc is a dummy substrate.

4. The optical disc according to claim 1, wherein an information recording area is formed on the base disposed away from the light incident side of the optical disc.

5. The optical disc according to claim 1, wherein at least one surface of the optical disc is coated with a dielectric film.

6. The optical disc according to claim 5, wherein the dielectric film is applied on the light incident surface of the optical disc.

7. The optical disc according to claim 5, wherein the dielectric film is a silicon nitride film or an aluminum nitride film.

8. The optical disc according to claim 7, wherein the silicon nitride film functioning as the dielectric film has a thickness of 300 nm.
